(19) United States
(12) Patent Application Publication
(10) Pub. No.: US 2004/0025191 A1
(43) Pub. Date: Feb. 5, 2004

(54) System and method for creating and presenting content packages

(75) Inventors: Maggie McDermott-Walsh, Bernardsville, NJ (US); Peter C. Olsen, Califon, NJ (US); Kristin K.C. Alexandre, Far Hills, NJ (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: B. Popular, Inc., Morristown, NJ (US)

(21) Appl. No.: 10/209,145

(22) Filed: Jul. 31, 2002

(51) Int. Cl. H04N 7/16; H04N 7/173

(52) U.S. Cl. 725/136; 725/8; 725/139; 725/4; 725/87

(57) ABSTRACT

A system and method by which programming is delivered via the internet to an end-user. The delivered programming can be based on specified selection criteria. The programming can be supported by information generated by support tools, including, but not limited to: ebooks, articles, games, content summaries, links to websites, telephone numbers, learning confirmation sessions, recommended reading and resources, etc. The service can be provided through a variety of revenue models. If a subscriber revenue model is used, the user can elect to pay for this programming in a number of ways, including either as a time-based subscription or on a pay-per-view/pay-per-topic basis.

### BACKGROUND OF THE INVENTION

The present invention relates to the creation and presentation of content packages, which can include various types of programming and segmented programming, the content package being presented over a communication network such as the internet.

“Programming” is any kind of audio and/or video and/or multi-media show created for and delivered to a consumer. Programming, therefore, includes a range of shows, and is typically delivered to the consumer via television and cable networks, satellite systems and radio systems. Programming will also be referred to herein as a “program” or “programs” or “shows.” Current examples or programs or programming include the “This Old House” home remodeling television series and the “Home Again” home remodeling television series. There are many other examples.

Entertainment and media companies have large libraries that include a vast range of television programming titles. These entertainment and media companies, however, have not been able to effectively, or profitably, extend the use of programming beyond traditional networks, for example, via the internet.

Consumers have a multitude of programming choices available through via television and cable networks and satellite systems and radio systems. However, consumers cannot access the programming on their own terms—namely when they want it and how they want it. Consumers are at the mercy of the broadcast schedules determined by the media and entertainment companies, the television and cable networks, the satellite systems and radio systems. Pay-per-view services are an alternative, but they offer only a limited set of shows, and the broadcast times are determined by the service provider. Products or services that help consumers “time-shift” and create modified versions of the programming for their viewing portfolios are available, but ultimately they are still dependent on the existing broadcast schedules.

The use of the internet to present programming offers different issues. While there is an abundant amount of information available on the internet, website operators have not yet been able to effectively, or profitably, offer programming to their visitors and/or subscribers. The reasons are multiple. One reason is the continued lag in broadband penetration and the resulting constrained demand for programming because download and/or streaming times are relatively long. This has resulted in frustration and/or abandonment of the programming by the visitor or subscriber. Another reason is attempts at original programming for the internet have failed. These failures appear to result from the misconception that the personal computer and the television are interchangeable, and that the population will seek out television-like entertainment programming via the internet. The present situation also suggests that consumers are not looking to the internet for new programming.

Moreover, programming as it is currently formatted, does not, for the most part, take internet consumers' content consumption habits into consideration. Online pay-per-view services like intertainer.com™ are offering “long form” programming to site subscribers/visitors (“long form” being defined as the duration of a program as it was broadcast or delivered in non-internet viewing venues, and does not include clips or snippets used to promote new programming). It is believed, however, that internet users are interested not only in on-demand procurement of content, but also in the procurement of such content in a way that is immediately relevant to an articulated need, and in a way that exploits the ability of today's technologies to personalize content products.

In addition, the programming available over the internet is currently limited to the programming alone. Even organizations like CNN™, which offers its RealOne™ sub-site subscribers a substantial amount of quality news programming, does not augment the viewer experience by offering access to additional media/information pertaining to a particular topic or interest. In this sense, the viewer is receiving only a relatively small slice of the potential content pie, and the provided content will likely not fully satisfy the needs of the viewer.

Accordingly, new methods and systems for presenting programming, including programming segments, and for creating content packages that can be displayed over the internet and over other networks, are needed.

### SUMMARY OF THE INVENTION

The present invention provides a system and method for creating content packages from programming, programming segments and/or additional information, and presenting selected parts of the content packages to consumers. The present invention allows a consumer on a network such as the internet—which has its own usage characteristics that are different from the usage characteristics of other media—to conveniently view programming and other topical information.

In accordance with one aspect of the present invention, a system and method for presenting programming, programming segments and/or additional information relating to one or more topics is provided. The system includes a plurality of database servers, each of the database servers being able to access a database that stores programming, a client terminal capable of specifying a topic and sending a request for programming related to the topic and a main server connected to the plurality of database servers and to the client terminal, the main server being capable of receiving the request from the client terminal, querying the plurality of database servers to create a content package that includes programming related to the topic and sending the content package to the client terminal. The system can also display the content package at the client terminal.

Once the client terminal displays the content package, a consumer can identify selected programming from a displayed content package, and send a request for the selected programming to the main server. The main server requests and receives the selected programming from the appropriate database server, and the main server transmits the selected programming to the client terminal. Then, the selected programming is displayed on the client terminal.

The system can charge a fee for the display of the selected programming. The system can also charge a fee for transmitting the selected programming from the database server. The system can store the fee information in one or more of the databases in association with the selected programming.

In accordance with a further aspect of the present invention, the programming is segmented and the segments are classified by topic. In accordance with this aspect of the present invention, the main server is capable of querying the database servers to identify programming segments related to the topic and then sending a list of the identified programming segments to the client terminal. The programming segments are preferably, but not necessarily, less than 5 minutes in length. The client terminal is capable of displaying the list of the identified programming and the list of the identified programming segments in a hierarchical fashion. The client terminal is also capable of allowing the consumer using the terminal to specify whether the main server should send a list of programming or a list of programming segments.

The main server can also have a local database that contains additional information relevant to the topic specified by the consumer. The main server is further capable of querying the local database to identify the additional information relevant to the topic and including the additional information in the content package.

The system and method of the present invention is capable of presenting programming that is fictional, non-fictional, and quasi-reality based. The system and method of the present invention is further able to present programming from any or all of the preceding categories that is television programming, video programming, audio programming and multimedia programming. In accordance with one aspect of the present invention, programming is categorized according to one or more programming categories, and the server can retrieve programming in accordance with its category.

The programming can also be categorized in accordance with a number of categories. These categories include, but are not limited to, people, time frames, genre, the previously mentioned categories of programming, etc.

The present invention also contemplates a system and method for presenting programming that is segmented, wherein the segments are related to one or more topics and are categorized in accordance with the relationship to the one or more topics. In accordance with the method, the segments are classified by topic. Then, a consumer wishing to view programming related to a particular topic selects that topic. Then, a content package that specifies a plurality of segments that relate to the topic is generated, and the content package is displayed to a consumer. The consumer can select any of the segments from the content package, and the selected one of the plurality of segments is displayed.

The consumer can also specify the category of programming to be viewed. This can be done apart from the specification of a topic, or can be done in conjunction with the specification of a topic. So, for example, if a consumer wanted to view “horror” movies, the consumer could also specify “Price” and “1960's” to further limit the programming contained in the content package.

In accordance with a further aspect of the present invention, the content package further includes additional information related to the topic, the additional information being selected from one or more of the following categories: a quiz related to the topic; an e-book presentation relating to the topic; a recommended reading list having a plurality of references relating to the topic; a summary of the topic; a top ten list related to the topic; and internet links to additional sources related to the topic.

The present invention further contemplates a system and method for presenting quasi-reality programming, as previously mentioned. In accordance with this aspect of the present invention, a program with some basis in reality and some basis in fiction is developed that presents issues relating to a topic. The programming is presented similar to the manner previously described. In accordance with one aspect of the present invention, however, the issues relating to the topic are presented from a number of perspectives. Thus, the quasi-reality program preferably includes one or more presentations relating to the topic that present a conservative perspective of the topic, one or more presentations relating to the topic that present a moderate perspective of the topic and one or more presentations relating to the topic that present a liberal perspective of the topic.

The present invention further contemplates that the content package includes additional information relating to the specified topic. For example, the content package can also include any of the following: a quiz related to the topic; a summary of the topic; a top ten list related to the topic; a game related to the topic, an e-book presentation relating to the topic, a recommended reading list relating to the topic, and internet links to websites related to the topic. Further types of additional information can be included in the content package.

### BRIEF DESCRIPTION OF THE DRAWINGS

FIG. 1 illustrates the generation of a content package from existing programming or programming segments in accordance with various aspects of the present invention;

FIG. 2 illustrates a system utilized for creating content packages and presenting programming from the content package;

FIGS. 3 TO 5 illustrate the process by which the content package is created and presented;

FIG. 6 illustrates the creation of a content package and the presentation of programming;

FIG. 7 illustrates a system having a clearinghouse server that interfaces with a plurality of program database servers to create content packages and to present programming in accordance with another aspect of the present invention;

FIG. 8 illustrates a database structure utilized in the present invention;

FIGS. 9 and 10 illustrate the presentation of television programming relating to a topic area selected by a consumer in accordance with the precepts of the present invention;

FIGS. 11 and 12 illustrate the presentation of quasi-reality programming relating to a topic area selected by a consumer in accordance with the precepts of the present invention;

FIGS. 13 and 14 illustrate the presentation of audio programming and other programming relating to a topic area selected by a consumer in accordance with the precepts of the present invention; and

FIG. 15 illustrates a schedule of payments for the presentation of content in accordance with various aspects of the present invention.

### DETAILED DESCRIPTION

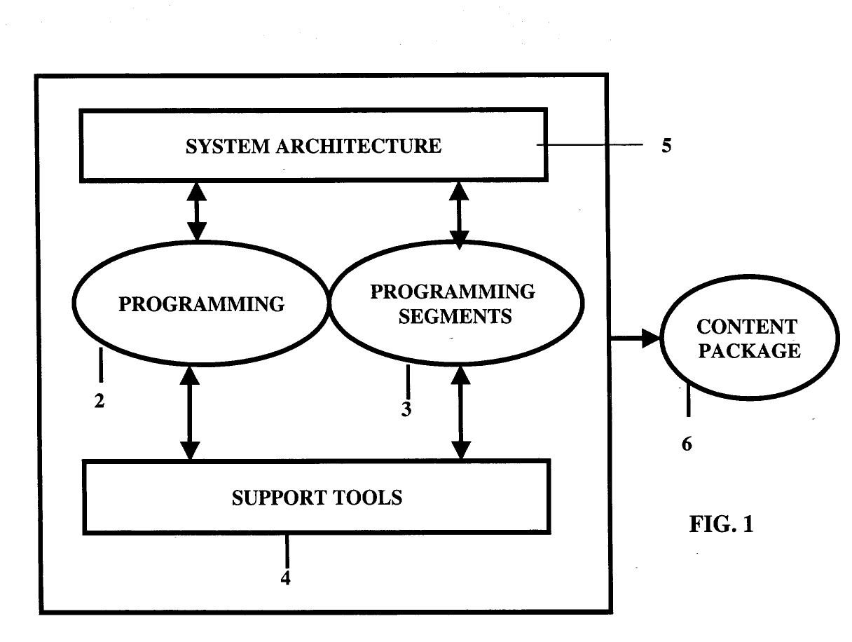

In FIG. 1, the creation and production of a content package 6 from programming 2 or from programming segments 3 is illustrated. The programming 2 can be a single program, but more generally includes a plurality of programs.

A great deal of programming 2 exists. Additionally, new programming 2 can be, and is being, created. As previously mentioned, this programming 2 includes any kind of audio and/or video and/or multi-media show created for and delivered to a consumer, and is typically delivered to consumers via the television or radio or other electronic media. The programming 2, however, is in a form that is not conducive to be presented on all types of media, and the use of the programming is therefore limited. The internet appears to be a particularly problematic medium in that the length of the programming is typically not conducive for display on the internet.

The programming 2 may be located in a single database, for example, a database that is maintained by a single entertainment company. Alternatively, the programming 2 may be located on a plurality of databases, and may include programming 2 owned by different entities. Thus, programming 2 from a number of different entertainment companies can be offered to a consumer in a single package in accordance with this invention.

In accordance with one aspect of the present invention, the programming 2 is divided into programming segments 3. The division or segmentation of the programming 2 is preferably done in accordance with topics, so that each program in the programming 2 is segmented by topic. The segmentation can be done when needed, on the fly, by accessing the database or databases containing the programming 2. Alternatively, and preferably, the topical segmentation can be done in advance and the programming segments 3 can be stored in a separate database, or a database can be created that indicates the start and stop points of each segment within the programming.

In accordance with another aspect of the present invention, a system architecture 5 is provided to allow consumers to access the programming 2 and the segmented programming 3, to allow the creation of a content package 6 based on the access provided and to allow the presentation of content packages. The system architecture 5 preferably allows multiple entities to specify topics and to access the programming 2 and the programming segments 3 based on topics. It also provides the capability for a content package 6 to be created based on the specified topic. Finally, it provides the capability to transmit and present the content package 6.

Support tools 4 are provided to assist in the creation of the content package 6. These support tools 4 include any supporting information or tool that can supply additional information related to the programming 2 or the programming segments 3 that are included in a content package 6. Thus, support tools 4 include, but are not limited to, text materials such as e-books, articles, points-of-view summaries, topical summaries, highlight lists, top ten lists, interactive materials such as a quiz or game and resource materials. The resource materials can include telephone numbers, web site addresses, internet links, and/or retail locations. Thus, the content packages 6 can include lists of programming or lists of programming segments or both, access to the programming or programming segments, and can also include information generated by the support tools 4 that are related to the specified topic and, therefore, to the programming or programming segments, so that a consumer of the content package can make greater use of the programming or programming segments.

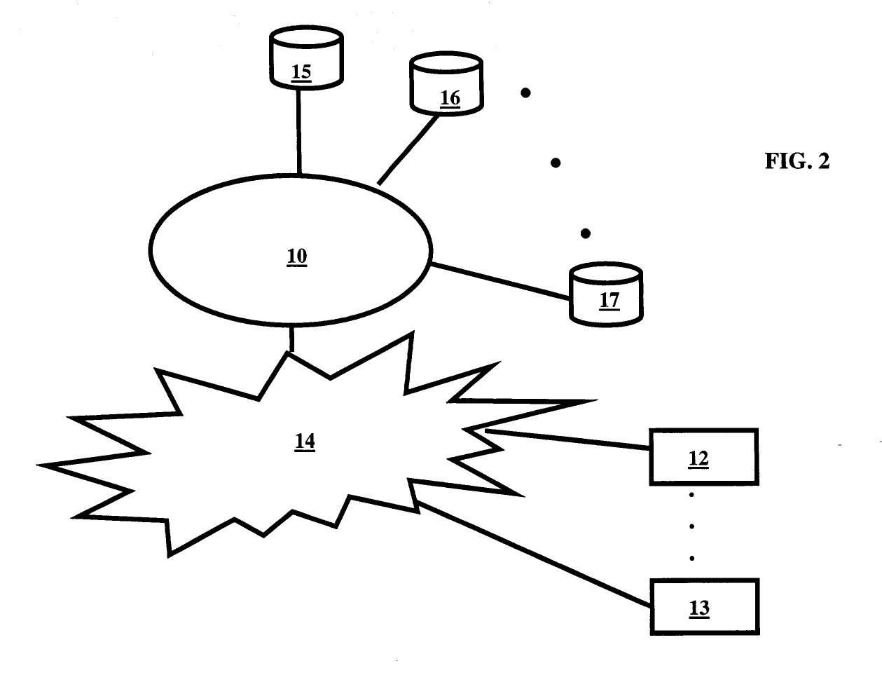

Referring now to FIG. 2, a system that can be utilized to present content packages 6 and programming is illustrated. A server 10 interfaces with a plurality of client terminals 12 to 13 through a networked medium 14. The client terminals 12 to 13 are preferably personal computers although they can be any networked device. Thus, the client terminals can include a wide variety of devices, such as personal digital assistants (PDAs), wireless telephones and the like. The networked media 14 is preferably the internet, but can include other communication medium. The server 10 preferably has access to one or more databases 15 to 17. The databases 15 to 17 include the programming 2 shown in FIG. 1. They can also include the programming segments 3 shown in FIG. 1, or, preferably the programming segments 3 are specified in a manner so that the segments can be generated from the databases containing the programming when a request for a topic is entered. The server 10 can be a website or an application server attached to a website. The server 10 can also be any other device that provides access to the databases 15 to 17 and to the networked medium 14.

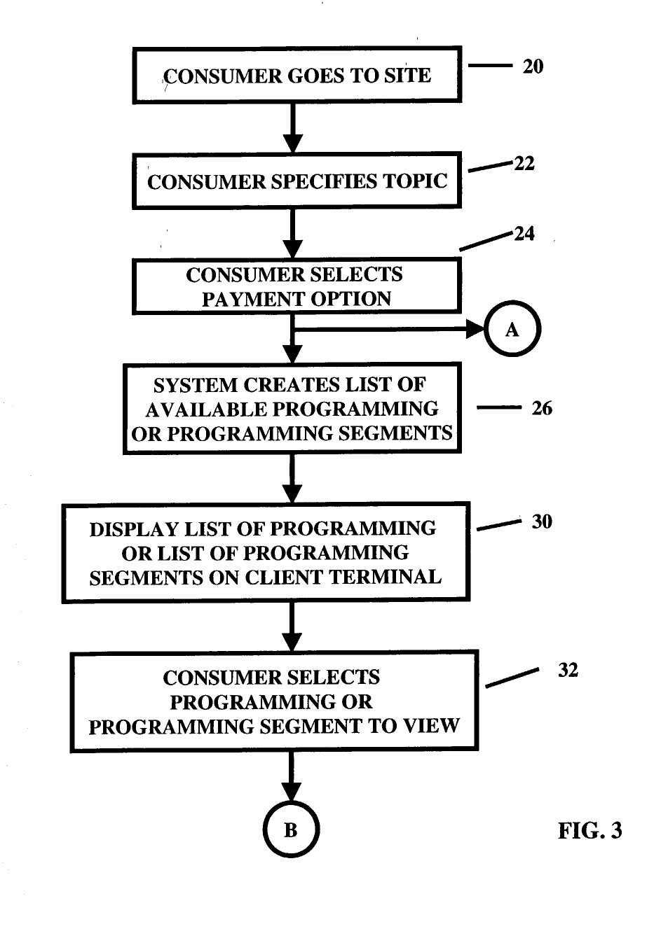

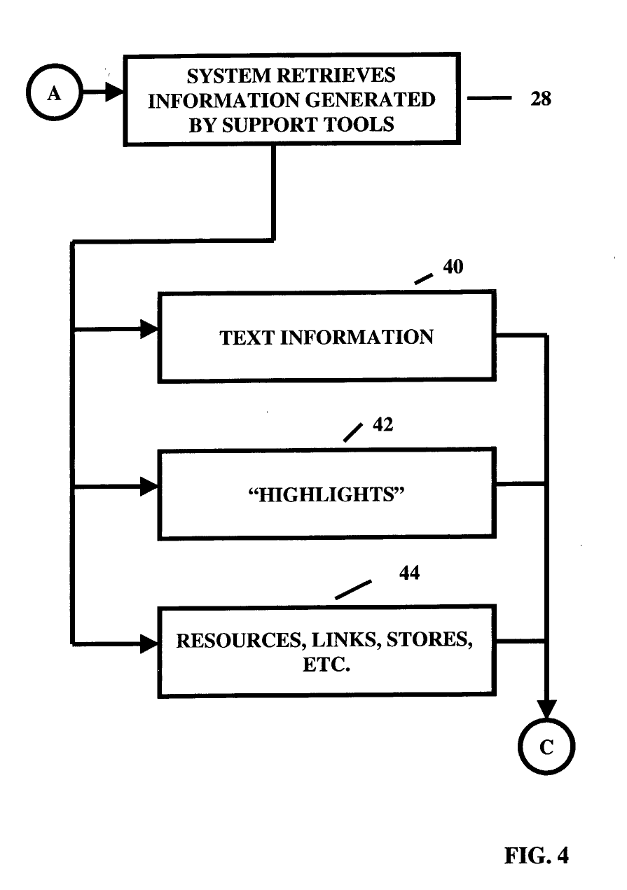

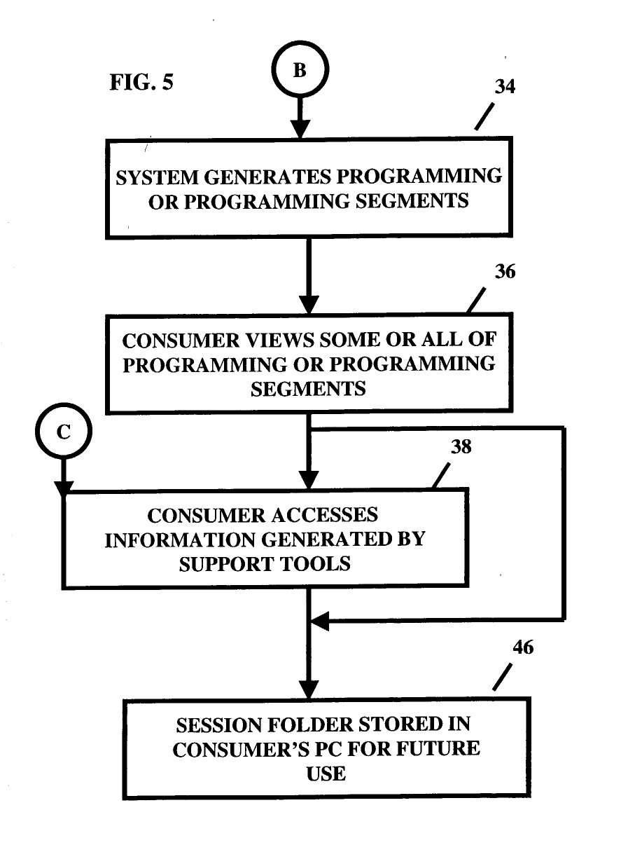

FIGS. 3 TO 5 illustrate a method of creating and presenting content in accordance with one aspect of the present invention. In step 20, a consumer preferably goes to a website that provides for the presentation of content in accordance with the present invention by accessing the server 10. In step 22, the consumer specifies an area of interest or a topic in which the consumer is interested. This is typically and preferably done by entering key words into a text box or by selecting one of a plurality of topics from a list box on a screen on one of the client terminals. Of course, as is well known in the art, a user interface that allows for either a selection from a list box or the entry of key words into a text box can be provided, and other well-known interfaces can also be provided.

In step 24, a payment selection interface can optionally be provided. The payment options will be discussed below. One option, however, is a flat period fee for accessing the site served by the server 10. In this case, the consumer would preferably enter a username and a password during step 24, and the server 10 would verify that the consumer was signed up as a flat fee user. Other payment options are also available. For example, a sliding fee scale can be utilized. If this is the case, a higher fee can be charged for more esoteric content packages.

After payment has been optionally made or verified, in step 26, the server 10 creates a list of available information or programming that is related to the area of interest or topic selected by the consumer in step 22. The server 10, in step 28, also retrieves additional information generated by the support tools that is related to the area of interest or topic selected by the consumer in step 22. The server 10 can optionally include the information generated by the support tools in the content package. Thus, the content package created by the server 10 can include programming only, and it can also include links to programming and support (or additional) information generated by support tools. As will be seen, the content package can also include links to programming or programming segments.

The server 10 can also limit the type of programming used to generate and present the content packages in accordance with the type of programming. For example, the server 10 can present only programming that is non-fiction programming, where non-fiction programming includes programming that directly derives from and/or depicts actual events that have occurred in the world at any given time. Examples of non-fiction programming includes news, documentaries, exposes, reality shows such as “Survivor” or “Real World.”

As another example, the server 10 can present only programming that is fictional programming, where fictional programming is programming whose primary basis is a narrative concerning characters and/or elements which do not have an actual material existence in the world. Examples of fictional programming include sitcoms, movies, music videos, commercials.

As a further example, the server 10 can present programming that is quasi-reality programming. Quasi-reality programming is programming that combines elements of fiction and non-fiction programming to create a facsimile of actual events in the world at any given time. An example of quasi-reality programming can be found at www.thedNd.com.

The server 10 can also present only television programming, such as existing television programs. The server 10 can also present only movies that are related to the selected area of interest. The server 10 can also present only radio programming or audio-related programming that is related to the selected area of interest. The server 10 can also present programming that is only sports programming. To accomplish this, it is preferable to include a programming type field in the databases to identify what class (or classes) every program or every programming segment fits into. One type (or class) or a combination of types (or classes) can be optimally selected by the consumer if this feature is included in the text or list boxes provided subsequent to the interface for the specification of the area of interest or topic.

Once the list of available programming related to the selected area of interest is created by the server 10, then, in step 30, the server 10 causes the list to be displayed on the client terminal 12 or 13 from which the consumer used to generate a request. The server 10 can present either a list of programming that is responsive to the topic specified by the consumer or a list of the programming segments that are responsive to the specified topic or both. It is preferred that the consumer be able to specify whether they are interested in the programming or the programming segments or both on the client terminal at which the request is generated. This can be accomplished by well-known interfaces, such as radial buttons, text boxes, list boxes, etc.

The server 10 then waits for a response from the consumer. In step 32, the consumer selects which programming or programming segments he or she would like to have displayed on their client terminal at that time. This can be accomplished in a number of ways, including, for example, by double-clicking on the appropriate line of the list that includes the desired program or the desired segment.

In step 34, the server 10 prepares the selected programming, programming segments and additional information to be presented on the client terminal 12 or 13 from whence the consumer initiated the request, and then presents the content package, including the programming, the programming segments and/or the additional information, as designated in step 32. The content package is preferably presented with logical groupings so that related programming and information is presented under a heading. It is further preferred that the programming and programming segments be displayed separately from the additional information generated by the support tools. It is also possible to display the programming/programming segments in a hierarchical form wherein a link to the program is specified, and links to all or selected segments of each program are listed underneath, and typically indented from, the link to the program.

In step 36, the consumer views all or part of the programming and/or programming segments. At the end of the presentation of the programming and/or programming segments, it is preferred to present the list of available programming and/or programming segments with an indication of which programming and which programming segments have been viewed or accessed.

The consumer, in step 38, can also select access to the support tools that the server 10 prepared in step 28. These support tools provide additional information that supports the programming previously presented, or if the server 10 is presenting programming segments, then the support tools provide additional information that supports the previously presented programming segments. The consumer can select the support tools at the end of the presentation, or at any time during the presentation. For example, a pop-up window having a list of available support tools can be displayed by the client terminal 12 or 13 when the consumer right clicks on his or her mouse. The additional information generated by these support tools preferably becomes part of a content package that includes a list of programming and/or programming segments that relates to a topic as well as the additional information that relates to the topic.

A variety of support tools were described earlier. One example of the support tools that can be presented in conjunction with the already displayed information or programming is text-based displays 40. The text-based displays include, but are not limited to, e-books, articles, and book reviews that are related to the area of interest identified by the consumer.

Another example of the support tools that can be presented in conjunction with the already displayed information or programming are highlights 42 that are related to the information or programming already presented or to the area of interest selected by the consumer. Highlights could include a “top ten” list of items or key points related to the selected area of interest, short or extensive quizzes relating to the selected area of interest and games related to the selected area of interest. These lists can be generated by topic, either by a person well before the consumer's request or by software in response to the topic indicated by the consumer. When generated by a person, the additional information is stored in a database connected to the server 10, and generated by reference to the database. The additional information is therefore preferably categorized by topic, and the additional information is stored in the database in association with one or more topics.

A further example of the support tools that can be presented in conjunction with the already displayed information or programming or programming segments are lists of additional resources 44 that are related to the information or programming already presented or to the area of interest selected by the consumer. These additional resources can include hyperlinks to other sites on the internet, lists of books, 800 numbers, contacts, telephone numbers and lists of stores having merchandise relevant to the selected area of interest.

This additional information generated from a number of different sources augments the information displayed in the selected programming or the selected programming segments. When the consumer selects any of the additional information, the server 10 causes that additional information to be displayed on the client terminal, thereby enhancing the robustness of the information presented so that the consumer's overall content experience is improved.

In step 46, when the consumer on the client terminal 12 or 13 terminates the session, it is preferred to store a session folder containing information relating to the session being terminated on the client terminal 12 or 13 for future use. Thus, the session folder includes information relevant to the session, such as the consumer's requested area of interest and other information sent to the client terminal 12 or 13 by the server 10. The other information can include an indication of what information was viewed and what information was not viewed. It can also include a list of resources. It can also include a summary of session highlights. The session folder is preferably stored in the consumer's client terminal for future reference.

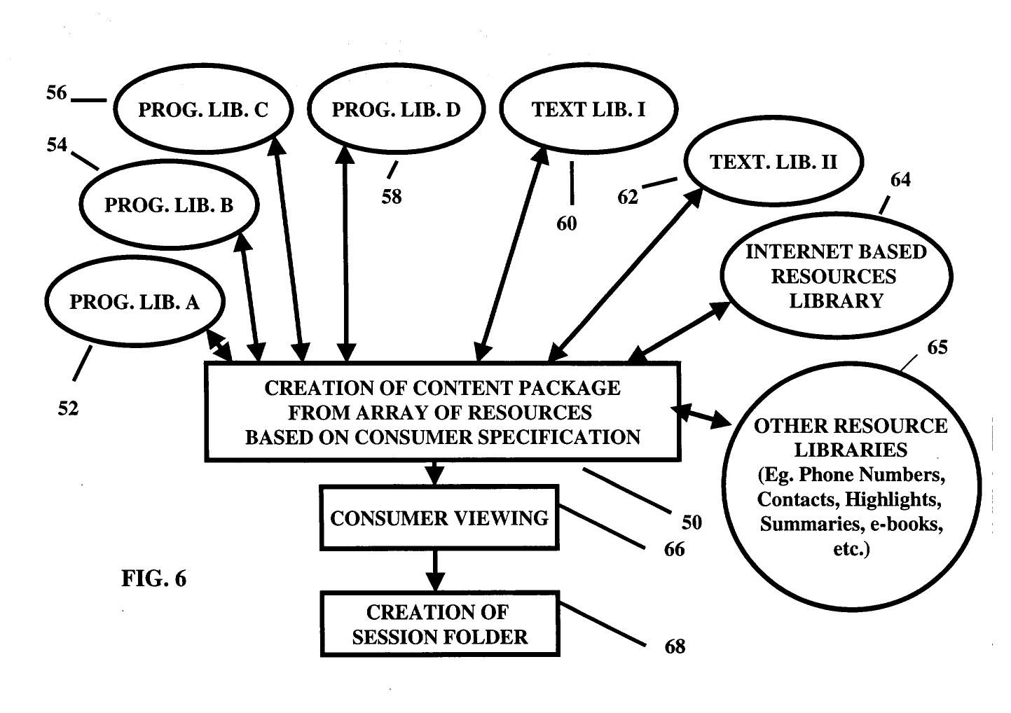

FIG. 6 illustrates the functional aspects of the presentation of programming, programming segments and content packages in accordance with the present invention from an operational perspective. The presentation of programming, programming segments and content packages illustrated in FIG. 6 applies to all types of programming, including but not limited to fictional, non-fictional and quasi-reality programming. It also applies to television programming. It further applies to video programming, to audio programming and to multi-media programming. In short, it is applicable to all types of programming.

In step 50, the consumer at the client terminal 12 or 13 specifies an area of interest or a topic in the manner previously described. This is preferably accomplished by entry into text boxes or selecting from list boxes. The system then has access, in the manner previously described, to an array of resources from which it creates the content package.

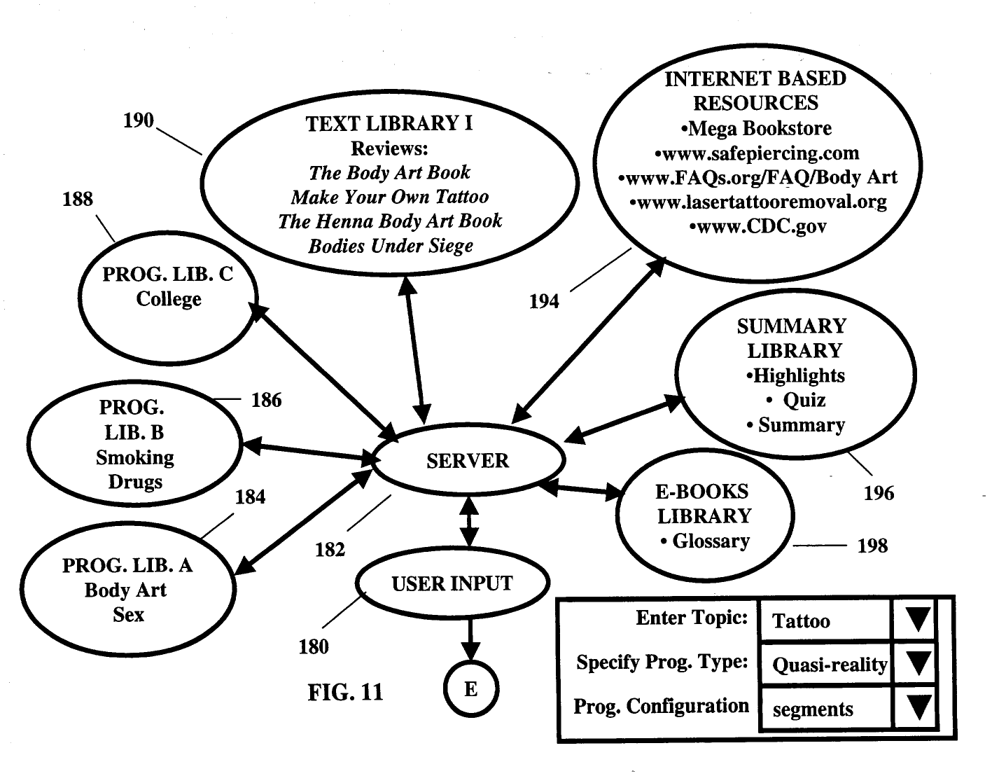

The resources can include one or more programming libraries, such as programming library A 52, programming library B 54, programming library C 56 and programming library D 58. In accordance with a preferred embodiment, the programming in the libraries 52, 54, and 56 is segmented or able to be segmented. The resources can also include one or more text libraries, such as text library I 60 and text library II 62. The resources can also include other internet-based resource libraries 64 and internet-based sources. The additional resources used to generate the content package can also include an e-book library and a summary library as shown in FIG. 11. Other resources 65, including any other form of additional information described herein, can also be used. These libraries are typically maintained at the server 10 in its databases 15 to 17. Alternatively, these libraries can be maintained at alternate locations that the server 10 can access, for example, via the internet or other databases. Thus, the information in the content package from the support tools is generated by accessing sources that are not libraries of programming.

Based on the topic specified by the consumer, in step 50, the server 10 creates a content package from the resources illustrated in FIG. 6. Thus, the content package can include programming, programming segments and additional information generated by support tools.

The content package is displayed to a consumer on one of the client terminals 12 or 13. In step 66, a consumer at the client terminal 12 or 13 selects the individual portions of the content package, including any of the specified programs, specified program segments and specified additional information. The consumer consumes as much of the content package as desired during a session. Thus, the consumer can view one or more programs, one or more program segments, as well as the information from the support tools, if desired. The consumer can also cut the session short at any time without viewing any or some portion of the information or programming. The previously mentioned generation of a session folder is illustrated in step 68.

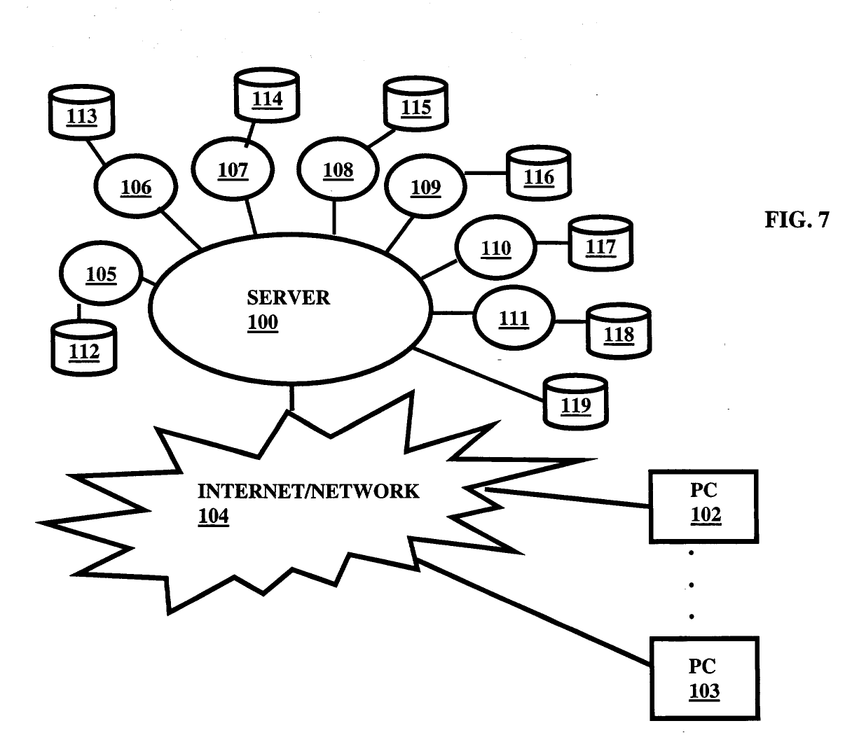

FIG. 7 illustrates another aspect of the present invention. In FIG. 7, an alternate architecture for generating content packages and for delivering the information in the content packages is illustrated. A clearinghouse server 100 interfaces with a plurality of client terminals 102 or 103 through a networked medium 104. As described before with respect to FIG. 2, the client terminals 102 to 103 are generally personal computers, but can be any networked device, and the networked medium is preferably the internet.

The clearinghouse server 100 also interfaces to a plurality of programming database servers 105 to 111. Each of the programming database servers 105 to 111 can access one or more databases of programming 112 to 118, respectively. Alternatively, any of the databases 112 to 118 can be directly interfaced to the server 100. Thus, for example, database 119 is directly interfaced to the server 100.

The programming in the databases 112 to 118 can include any programming, so, for example, the programming in the libraries illustrated in, and described with respect to, FIG. 6 can be included. The information generated by the support tools can also be included in the databases 112 to 118, or, as previously mentioned, the information generated by the support tools can be accessed via the internet 104 and generated from the accessed information. Further, a separate server can be incorporated to manage the generation of additional information by the support tools. Further, the interface between the clearinghouse server 100 and the programming database servers 105 to 111 can be via a direct link, via the internet or via another source.

In the system illustrated in FIG. 7, when a consumer specifies an area of interest, or some other criteria, the clearinghouse server 100 receives the consumer's request. The clearinghouse server 100 relays the request, whether it is for an area of interest or a topic or another characteristic of the programming, to each of the programming database servers 105 to 111. Each of the programming database servers 105 to 111 process the consumer's request by accessing their programming databases 112 to 118, respectively. Each of the programming database servers 105 to 111 generate a list of responsive programming, or a list of responsive programming segments, depending on what the consumer wants to view Then, each of the programming database servers 105 to 111 provide a list of programming that is related to the consumer's request to the clearinghouse server 100. Next, the clearinghouse server 100 generates a content package. The content package includes a master list of related programming and related programming segments, keeping track of where the programming and related programming segments are located. Thus, the clearinghouse server 100 knows the location of the programming and the programming segments, that is, the clearinghouse server 100 knows which database 112 to 119 the programming or programming segment is in for future reference in case the consumer desires to view certain programming or programming segments during the display of the content package or listing of programming. The content package can also include the information from the support tools, as previously described.

The clearinghouse server 100 causes the content package to be displayed at the consumer's client terminal 102 or 103. This includes the display of the master list of programming and programming segments, which may include programming or programming segments from a plurality of programming databases 112 to 119. The consumer then specifies which programming, programming segments or additional information from the support tools to view. Based on the consumer's specification and on the known location of the programming, programming segment or additional information, the clearinghouse server 100 accesses the programming or programming segments or additional information and displays it to the consumer. Then, the consumer consumes one or more of the items in the content package, including the programming, programming segments or additional information in the manner previously described.

Thus, the system of FIG. 7 allows programming from a variety of sources to be conveniently viewed by one or more consumers. The consumer conveniently only needs to access a single website to have access to a wide variety of programming from a wide variety of sources. For example, one of the database servers 105 and its associated databases 112 could be provided by one entertainment company with an established library of programming, a second of the database servers 106 and its associated databases 113 could be provided by another entertainment company with its own established library of programming, and so on.

In accordance with one aspect of the present invention, the programming is segmented. Further, when the programming is being presented over the internet, it is preferred that the programming be segmented so that individual segments can be viewed in lengths of time that are more in line with how the internet is used.

Thus, the programming is divided or broken down into one or more segments. The segmentation is preferably done on a topical basis, and each segment is classified by the topic of the segment. Each of the segments of programming can be further classified in accordance with many different parameters. So, by way of example only, segments can be classified by a relevant time frame, in accordance with types of programming (e.g., television, video, audio, multimedia, fiction, non-fiction, quasi-reality). In accordance with a preferred embodiment, segments which can be viewed within a range of 1.5 minutes to 5 minutes are preferred, although segments outside this range of time can also be used. It is believed that segments of a 1.5 minute to 5 minute length will make programming that is provided over the internet more viewable to consumers, and will therefore increase the value of existing programming owned by a variety of entertainment companies.

Thus, as illustrated in FIG. 1, programming segments 3 are preferably available with every embodiment of the present invention. Referring to FIG. 2, the programming or information available to the server 10 can be segmented. So, for example, the programming or information in the databases 16 and 17 is either segmented or the segments are specified so the server 10 can generate the proper segments upon receiving a request for an area of interest.

In FIG. 3, when the server 10 prepares a list of programming, the server 10 can prepare a list of segments available and display that list to the consumer on the client terminal 12 or 13. Alternatively, the server 10 can first prepare a list of programming available, display the list, and then display the available segments based on the selected programming. The server 10 can also present a hierarchical list of the available programming and the segments available for each content package or for each type of the available programming or information. In this case, as previously described, the available programming would be presented as one level, and the segments available for each of the available programs would be presented as a lower level. For example, the listing could be provided in outline form, wherein each program may be listed without indentation, and each segment for each program may be listed under the program with a single tab indentation. Referring to FIG. 6, where the programming is segmented, the programming in one or more of the programming libraries A to D (52, 54, 56, and 58, respectively) is preferably segmented.

Lastly, referring to FIG. 7, when segmented programming is utilized, one or more of the programming databases 112 to 118 would also contain programming that was either segmented or capable of being broken into segments. In the later case, the segments are preferably already specified so that the respective programming database server 105 to 111, respectively, can generate the proper segments upon receipt of the consumer's request for programming relating to an area of interest. The clearinghouse server 100 can present lists of segmented programming, as well as the actual programming segments, to the consumers on the client terminals 102 to 103.

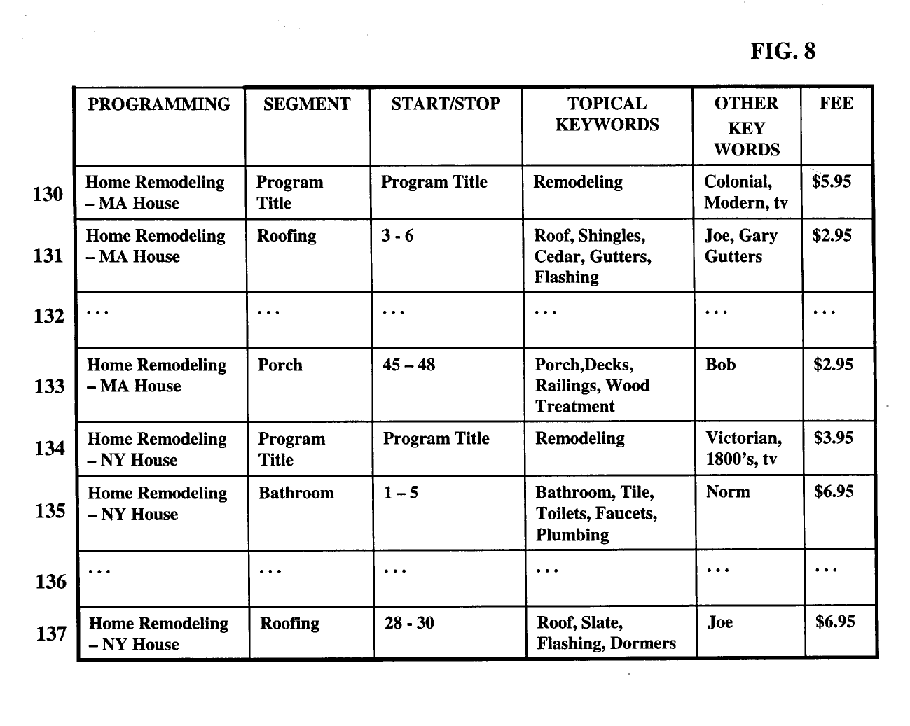

The segmentation of programming can be accomplished manually. In accordance with this aspect of the present invention, an individual would decide how to segment a program into optimally viewable segments. For example, such a person would view the programming and make decisions as to how to segment the program by topics. These decisions could be aided by the availability of topics from the text and/or list boxes entries, and by the keywords included in the database (see FIG. 8). In this case, one or more topics could be associated with each individual segment of programming. Additionally, each individual segment of programming could be further classified, as explained earlier. The programming segments, the related topics and the related classifications would then be stored in a database so that the server 10 or the server 100 can read the database to determine what segments are related to consumer's related topic and any specified classifications, prepare a list of the related topics, and then present the programming to the consumer as a list and as individual segments.

Further, the segments are preferably specified by means of start and stop time tags associated with the programming to which the segment is related. Thus, a segment is accessed by referring to the programming that the segment was generated from, and accessing the programming at the point specified by the start time tag. Access continues until the stop time tag is reached, at which time the segment ends.

Referring to FIG. 8, a database that categorizes the programming segments, and enables the segments to be accessed, is illustrated. The database of FIG. 8 illustrates two different programs—Home Remodeling (MA House) and Home Remodeling (NY House). Each of these programs is programming that was developed as part of the same television show, and are similar to the well-known television home remodeling/home repair shows. Thus, the programming illustrated in FIG. 8 shows the remodeling of two homes, one in MA and one in NY. Of course, there are typically many programs referenced in the database in accordance with the principles of the database format of FIG. 8.

The section of the database illustrated in FIG. 8 includes a first program Home Remodeling—MA House, which is listed in row 130 of the database. The words “Program Title” in the segment column and in the start/stop column of the database indicates that that this row refers to the entire program. This program may coincide with a single television program that was presented on televisions in a single programming slot (i.e. a half hour or an hour slot), or the program may also be organized such that it represents all programming slots relating to the remodeling of the MA House, or the program may also be organized such that it represents all segments in the program. In the first case, there will be a fewer number of segments, whereas in the latter case, there will be a greater number of segments. It is preferred that each row represent programming as it has been formatted for a single programming slot.

The multiple segments associated with the Home Remodeling—MA House program are illustrated in rows 131 to 133 of the database. The segment column of the database indicates the title of each segment. The start/stop column is utilized by the server 10 or 100 to identify where individual segments start and stop in the original programming, as previously described. The topical keywords column indicates the topic or topics associated with each segment. The other key words column indicates other characteristics of each segment, such as the names of people involved, the type of house involved, the type of programming, as well as other characteristics of the programming. Lastly, the fee column indicates a fee associated with the transmittal or display of the programming or the programming segment.

Thus, referring to FIG. 8, the first segment of the programming Home Remodeling—MA House is specified in row 131 of the database. The title of the segment is roofing. It should be recognized that the subject of roofing the MA House may, and probably was, illustrated over several programming slots when the programming was first presented on television. In this case, the database will contain multiple segments on roofing the MA House.

The 3-6 in the Start/Stop column of the database are time tags that indicate that the segment starts 3 minutes into the program and ends 6 minutes into the program. The server 10 or 100 uses this information to find the segment within the programming in the program databases. As previously described, this can be accomplished via time tags associated with the programming. It can also be accomplished by counting the time frame into the programming, and starting the segment at the start time and ending the segment at the stop time. Other methods of generating segments of programming are also available. For example, counters, similar to those used in VCRs could also be used. In more sophisticated editing systems, these counters could be digitized.

Still referring to row 131, the next column in the database, Topical Keywords, indicates what the segment is related to. Thus, the segment in row 131 relates to roofs, shingles, cedar, gutters and flashing. The server 10 or 100 uses this column and the topic specified by the consumer to generate the content package.

The next column in the database, Other Key Words, further specifies what the segment is related to. Thus, the further classifications of the segments, as previously discussed, are specified here. Referring to row 131, in that segment Joe and Gary Gutter perform the work. It is recognized that many other classifications can also be specified. By way of example only, the classification of “tv” in row 130 is construed to apply to all segments in the programming on row 130. The server 10 or 100 would also search this column in the programming title row (130) when creating the content package so as to incorporate a consumer's desires.

Thus, for example, if the consumer only wanted to see television programming, they would include that specification with the topic that is specified to the server 10 or 100, as previously described. Thus, the interface at the client terminals can also include a specification of the various classifications previously discussed. For example, the type of programming, the people involved, genres, time frames, etc. can be specified to the server 10 or 100.

The last column is the fee column. This column specifies the fee associated with either transmitting or displaying the programming or the programming segment. Thus, the fee could be charged by the entity owning the program database to the clearinghouse server 100 for actually transmitting the programming or programming segment to the server. Typically, this fee would only be charged when the consumer actually wants to view the programming or a programming segment so that a transmission of the programming or programming segment must be made. This column could also specify the fee that could be charged by the clearinghouse server 100 to the consumer for viewing the programming or the programming segment.

It is noted that even if the programming is not segmented, one or more topics are assigned to each individual program, and a database that has the programming and the associated topics is provided. Further, any of the classifications for each individual program previously discussed can be specified in the database. The servers 10 or 100 can access the database once a requested topic is received from a consumer to determine what programming is responsive to the topic and any further classifications to prepare a list to be presented to the consumer.

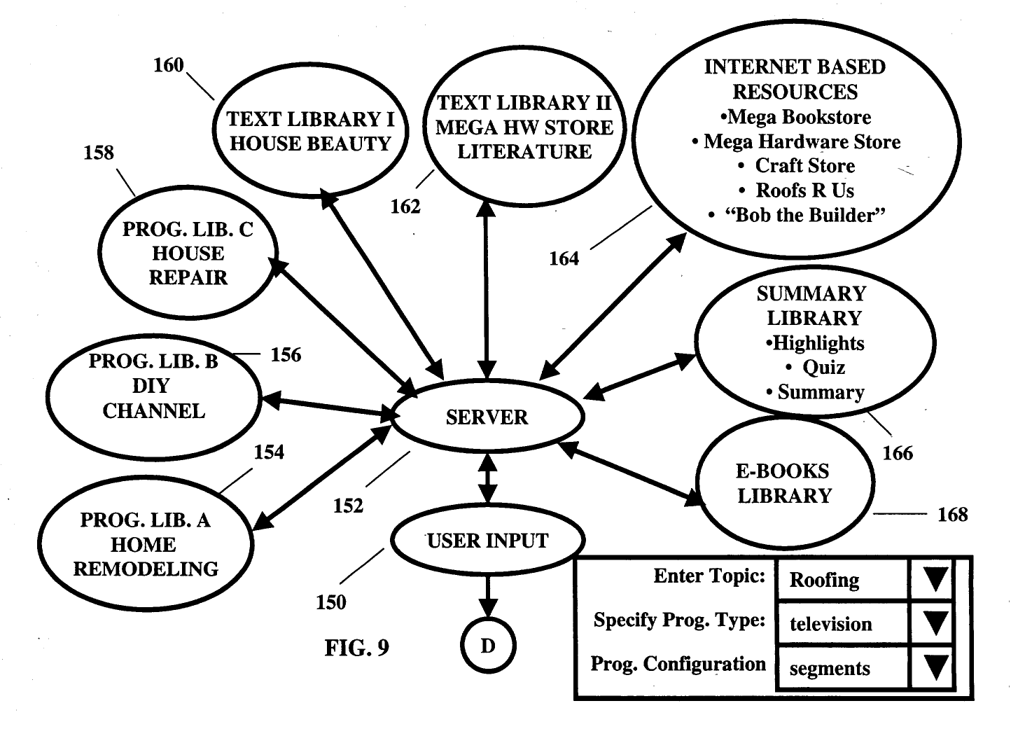

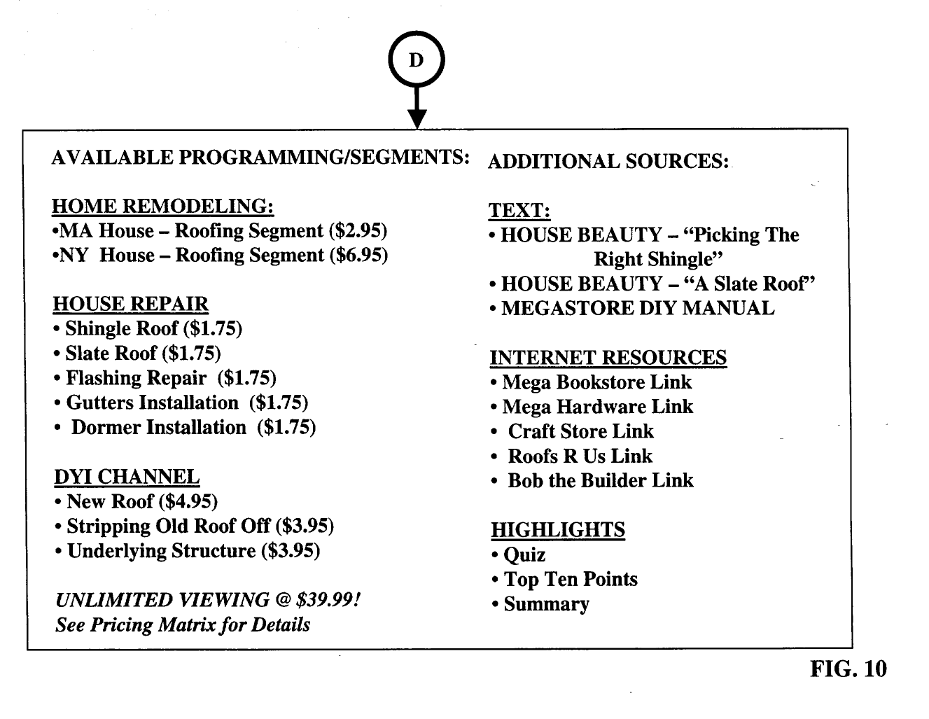

The creation and displaying of content packages, and the resulting display of programming, programming segments and support information has been discussed. As alluded to, various types of programming can be displayed. Referring to FIGS. 9 and 10, the creation of a content package that includes television programming, television programming segments and related support information is illustrated.

The process begins with a consumer specifying the relevant criteria for the content package desired. In the case of FIG. 9, the consumer, in step 150, has utilized a list box to specify roofing as the topic to be presented. In this step, the consumer has also utilized another list box, although a number of user interfaces can be used to specify all of this information, to specify that the content package should contain television programming. This request is sent to the server 100.

In step 152, the server 100 searches a number of programming libraries. Referring to FIG. 7, these libraries are contained anywhere in the programming databases 112 to 119. Referring back to FIG. 9, three relevant libraries (there can be many more)—including Programming Library A 154, Programming Library B 156 and Programming Library C 158 are illustrated.

The programming contained in Programming Library A 154 includes programming from a hypothetical Home Remodeling television show. It is noted that it could contain programming from other shows. So, for example, if an entertainment company owned a number of home repair/remodeling shows, they may keep all of their related programming, or even their unrelated programming, in this library. The programming in the Programming Library B includes programming from a hypothetical DIY Channel, which was previously shown on cable television. The programming in the Programming Library C 158 includes programming from hypothetical Home Repair shows, which were also previously shown on traditional television channels. Although this example uses television programming, the programming could also be video programming.

Each of these programming libraries 154, 156 and 158 respond to the request from the server 152 which is based upon the consumer's input, by providing programming or programming segments that are related to the topic and other characteristics specified by the consumer. As illustrated in FIG. 9, the consumer can also specify whether they want to view segments or not. The operation in FIG. 9 is presented functionally. Referring to the clearinghouse architecture of FIG. 7, the server 100 receives the request from the consumer. The clearinghouse server 100 distributes the request to the database servers 105 to 111. The database servers 105 to 111 access their databases 112 to 118. The databases 112 to 118 have data structures as illustrated in FIG. 8, or similar structures that specify topics and other characteristics of programs and programming segments. The database servers 105 to 111 search the databases 112 to 118 to identify potential programming and programming segments to include in the content package in the manner previously described with respect to FIG. 8. This information is then transmitted by each server 105 to 111 to the clearinghouse server 100. The clearinghouse server 100 organizes this information for inclusion in a content package. The clearinghouse server 100 will typically include rules concerning the size of the content package, and may have to limit the size of the content package in accordance with those rules by not including some of the programming or programming segments in the content package.

Referring to FIG. 10, the content package generated by the steps of FIG. 9 is illustrated. The programming and programming segments generated by search the programming libraries 154, 156 and 158 and included in the content package formed by the server 100 are illustrated in the left hand side.

In this case, the consumer has chosen to include segments only in the creation of the content package. Thus, only programming segments are illustrated in FIG. 10. The consumer could have also specified programs only or a combination of programs and program segments.

The programming segments included in the content package include segments from the Home Remodeling show. The programming segments include a roofing segment from the MA House and a roofing segment from the NY House. How these shows were identified can be seen with reference to FIG. 8. These segments were identified by a search of the database for the keyword roof, which identified the program segments in row 131 and row 137 as relevant segments to include in the content package.

Other programming segments from the Home Repair show and the DIY Channel shows are illustrated in the programming side of the content package of FIG. 10. It is preferred to include a price per viewing with each of the programming segments, as illustrated in FIG. 10. This fee can be specified by the fee in the database of FIG. 8. Alternatively, the fee can be specified by the clearinghouse server 100. Further, if a fixed price payment method is selected, wherein unlimited viewing for a period of time is in effect, then the fees associated with each programming segment do not need to be shown.

In step 152 the server 100 also responds to the consumer request for a content package by searching for related information from other sources, the so-called support tools. The other sources include the text materials, the internet-based resources and the highlights, as previously described. Referring to FIG. 9, the text-based materials are provided in the Text Library I 160 and the Text Library II 162. As before, the text materials in the libraries 160 and 162 can either be keyword coded or the derivation of relevant segments can be based on a search of the articles themselves for key words. In either case, in the example of FIGS. 9 and 10, the relevant articles owned by a hypothetical publisher, House Beauty, is identified from the library 160. Further, the relevant text segments from a large chain store selling hardware (such as Home Depot) contained in the library 162 are identified and included in the content package. This could, for example, include segments from a do-it-yourself manual.

The internet-based resource library 164 includes references to internet websites that are identified as being relevant to the consumer request by virtue of key words. As illustrated, this list of resources is provided to the server 100 in step 152. Further, this information is included in the content package, as illustrated in FIG. 10. A local resource library 166 provides a quiz related to the consumer's request, and also provides highlights and/or a summary of information available based on the consumer's request. For example, the top ten points associated with installing a roof may be presented. This information is also preferably included in the content package as illustrated in FIG. 10. An e-book library 168 also supplies related information that is included in the content package, including text, to the server 100 in response to the consumer's request.

Once the server 100 has accumulated all the relevant programming segments from the libraries 154, 156 and 158, and has accumulated the relevant information from the support tools found in the libraries 160, 162, 164, 166 and 168, the server 152 organizes the information into the content package illustrated in FIG. 10. The content package is essentially a list of available resources to present to the consumer based on their request.

FIG. 10 illustrates one form of presenting the content package where programming and/or programming segments are displayed on the left and additional information that is not programming generated from the support tools is displayed on the right. Many other ways of displaying the content package are possible.

Once the content package is displayed to the consumer on the consumer's client terminal, the consumer can view programming, programming segments and additional information by selected the item to be viewed from the content package. This is preferably accomplished by double-clicking on the desired line of programming segment. Thus, if the consumer wants to see the MA House segment on roofing, a double-click on that line on the left hand side of the content package of FIG. 10 will cause the server 100 to access the Programming Library A 154 to retrieve that programming segment. This is accomplished in the previously described manner. The server 100 then transmits that segment to the consumer's client terminal via conventional techniques so that the consumer can view the segment.

After the segment or other information is viewed, the server 100 preferably causes the content package of FIG. 10 to be displayed again. The server 100 also preferably causes the programs, the programming segments and the additional information already viewed to be highlighted. In this way, the consumer can readily see what has been viewed.

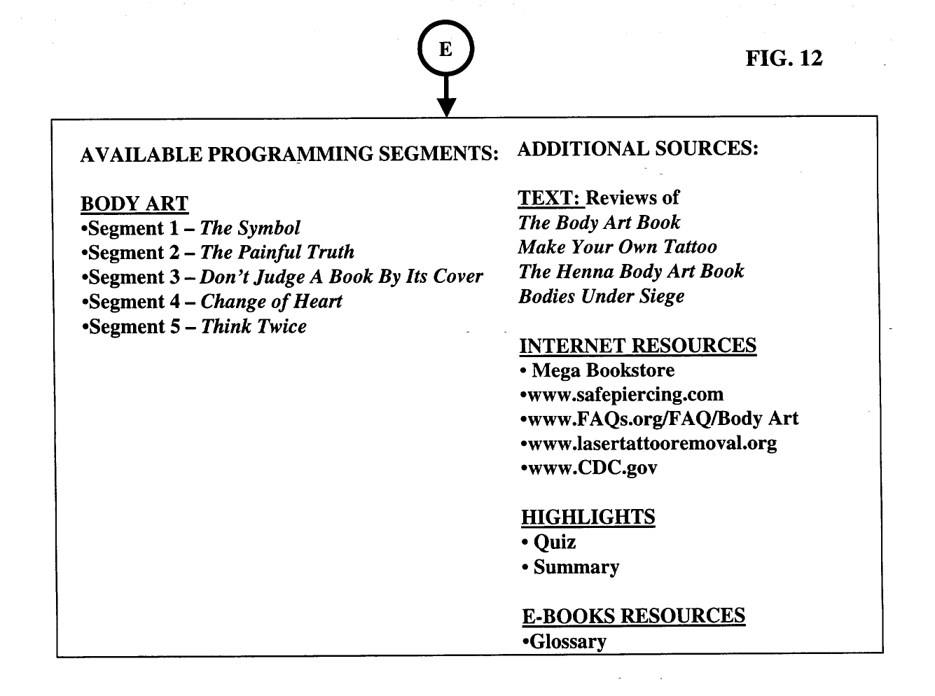

Now referring to FIGS. 11 and 12, the use of quasi-reality programming to create a content package that can be displayed to a consumer via the internet is illustrated. The presentation of quasi-reality programming uses the same principles as the presentation of programming previously explained, including the example of the use of television programming with respect to FIGS. 9 and 10.

Thus, in accordance with this aspect of the present invention, the programming databases include a plurality of quasi-reality programs. The content package that will be generated in the examples of FIGS. 11 and 12 could be generated from a special purpose server that only has access to quasi-reality programming, such as a production company or other company may offer. Alternatively, as should be appreciated from the earlier descriptions, the content package that will be generated in the examples of FIGS. 11 and 12 could be generated from programming databases that include other types of programming. In this case, the consumer will have specified that only quasi-reality programming is desired.

These quasi-reality programs address a wide range of topics of current interest to a group of individuals. For example, a company may develop quasi-reality programming to help young teens become educated on important topics and issues of particular interest to that age group. The quasi-reality shows will typically combine fiction and non-fiction elements to create a unique blend of information, relevance and entertainment. In this example, the core message of the show will be for teens to be sure to gather facts before making a decision, and to help the teens understand the potential consequences of their decisions.

In accordance with the present invention, it is preferred to present the information with three fictional characters, and to present the information in a balanced format. Thus, the information is presented from a conservative point of view, from a moderate point of view and from a liberal point of view. Such a balanced presentation helps a consumer of the information to achieve the previously expressed goals. While it is preferred to utilize three fictional characters, more or less can also be used.

Referring to FIGS. 11 and 12, the generation and display of a content package using quasi-reality programming and additional information is illustrated. In FIG. 11, three programming libraries A 184, B 186 and C 188 all contain quasi-reality programming. As mentioned before, the libraries can contain all types of programming from a variety of sources but, in this case, the service is being offered by a single company that produces, or has produced, the quasi-reality programming for a web site. The quasi-reality programming is preferably, but not necessarily, segmented, as shown in FIG. 12.

In the example of FIG. 11, the consumer, in step 180, can select from a list box of topics, or can enter their own topic in the text box, to access the programming libraries. In FIG. 11, the consumer may be considering a tattoo, and selects the topic “Tattoo” to explore the issues involved in getting a tattoo.

This request is sent to a server 10 or 100 in step 182. The server 10 or 100 sends the request to the programming libraries 184, 186 and 188. In the case of FIG. 11, only Programming Library A 184 has programming relevant to body art. The server 10 or 100 preferably determines this by referring to a database with a data structure similar to the one previously discussed with respect to FIG. 8. Thus, topical keywords are preferably assigned to the quasi-reality programming and to the individual segments of quasi-reality programming. Where the quasi-reality programming is greater than five minutes in length, it may be necessary to include the start/stop time tags or other counter methods to identify the segments. In a preferred embodiment, however, the quasi-reality programming is produced for presentation on the internet, and therefore is already in segments, each having a length of five minutes or less. In this case, the individual segments are stored in the database, and the start/stop tags are not necessary.

In the example of FIG. 11, there are five Body Art episodes or segments in the Programming Library A 184, each of which is preferably less than five minutes in length. In order to meet the goal of providing a balanced presentation of information, the quasi-reality program that includes the five segments includes presentations by three characters. The characters can be fictional or non-fictional, cartoon characters (or the like) or real people. In accordance with one aspect of the present invention, each character presents the issues from a different perspective. Thus, character 1 could be a conservative, character 2 could be a moderate and character 3 could be a liberal. In this case, the term “conservative” is understood to have its conventional meaning, for example, the belief that tradition defines what ideas and behaviors are right and good, and are perceived as unwilling to forge new ground. Also, the term “liberal” is understood to have its conventional meaning, for example, a liberal has the tendency to support more progressive ideas and behaviors, many of which tend to break with tradition, and are perceived as willing to take more chances. Further, the term “moderate” is understood to have its conventional meaning, for example, a moderate would have the tendency to balance or juggle conservative and liberal views.

It should be understood that while the actual number of characters can change from segment to segment, a standard set of characters is used for the program. Further, it is not necessary that every segment include all three previously described perspectives. In fact, to meet the desired length of a segment, it may be preferable not to use each character in every segment. All of the related segments that constitute one quasi-reality program on one issue, however, when considered as a whole, should include all three perspectives during the course of all of the segments. Thus, segment 1 could provide the conservative view, segment 2 could provide the moderate view and segment 3 could provide the liberal view. In accordance with a preferred embodiment, however, it is preferred to present multiple perspectives in a segment.

The preferred structure of each quasi-reality show is that in the first segment, one of the three characters finds him or herself facing a particular fictional problem in a topical area. In subsequent segments, preferably, but not necessarily, all three of the characters go out into the real world to talk to experts on the topic, expressing their unique perspective during the discussions. Then, the final segment consists of the three characters regrouping in a fictional space to discuss what they found out during their discussions with the experts, once again with their unique perspectives being expressed.

Referring to FIG. 12, the search in step 182 of the programming libraries 184, 186 and 188 identifies the five “Body Art” segments in library 184, as shown in the content package. In these segments, which are merely examples of quasi-reality programming useful in the present invention, Karen represents a conservative point of view, Robert represents a moderate point of view and Mary Jo represents a liberal point of view.

Segment one is entitled “The Symbol.” In segment one, Mary Jo, the liberal character is considering getting a tattoo or piercing because it seems cool. Mary Jo talks to her friend, her mother and her brother about the idea. Segment two is entitled the “Painful Truth.” In this episode, Karen, Robert, and Mary Jo visit a tattoo parlor to see what the process entails, to learn the requirements and risks and to learn about less permanent options. Segment three is entitled “Don't Judge a Book By Its Cover.” In this segment, Robert talks to a tattoo “addict” to get a better understanding of why people get tattoos and how the public views people with tattoos. Segment four is entitled “Change of Heart.” In this segment, Karen talks to a girl who got tattoos and piercings because it seemed novel at the time, but who now wants to remove them. Karen also talks to a laser tattoo removal doctor. Segment five is entitled “Think Twice.” In this segment, Karen, Robert, and Mary Jo regroup to discuss their findings in a manner such that the conservative, liberal and moderate perspectives on the issue are clearly presented, and Mary Joe is given balanced information to help her with her decision about getting a tattoo.

Each of these segments can be viewed by clicking on the segment in the content package displayed in FIG. 12. The content package of FIG. 12 includes a list of additional information on the right side, in addition to the previously described segments. The additional information is derived in a manner similar to that previously described. Thus, in step 182 the server 10 or 100 searches text libraries 190 and 194, summary library 196 and e-books library 198. A database similar to the one described in FIG. 8, where information is associated with key words so that the information relevant to a topic can be identified, is maintained for each of these libraries containing additional information. Thus, when the server 10 or 100 searches for additional information, it identifies various book reviews from text library 190, various internet links to sites having relevant information in internet resource library 194, various quizzes and summaries in the library 196. Various e-books and glossaries can also be specified in the library 198. These libraries are preferably created and cross-referenced to topics by the previously described database structure (see FIG. 8), as part of the service provided by the company implementing the server and the delivery of the quasi-reality programming.

The previous segments were illustrative only. Numerous other topics can be addressed by this structure and methodology. By way of example only, smoking, cheating, nervous habits, reputation, violence in schools, becoming sexually active, data rape, STD's, bullies, what is cool anyway, ADD and ADHD, marijuana, fitting in, being different, Oxycotin, ecstasy, are you in control, dieting, stress, guns, gaining self-confidence, body image, fitness pressures, clubs, raves, parent problems, being gay, getting dumped, revenge, how to stand up for what you believe in, sexual harassment, what is safe sex, truth about college, money, periods, wet dreams, popularity, what is sexy, changing friends, religious differences, defining success for yourself, are but a few examples of issues that can be addressed by the quasi-reality programming method and system described herein.

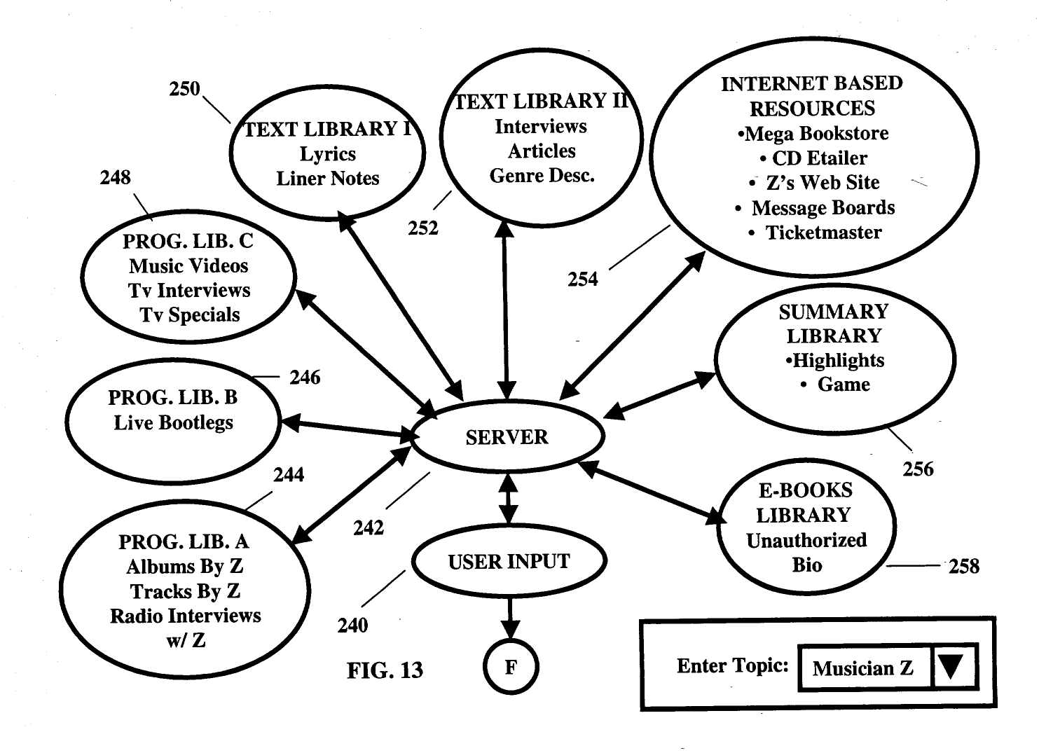

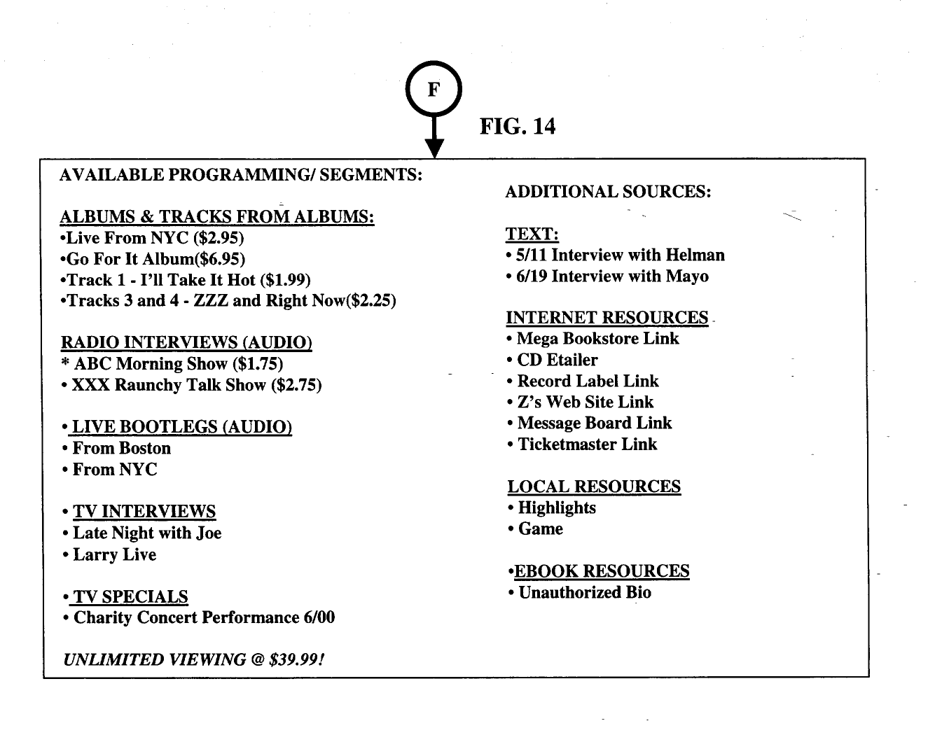

Referring now to FIGS. 13 and 14, the presentation of primarily audio programming is illustrated. Again, the principles of the creation of a content package from programming, programming segments and secondary information that have already been described are utilized. The content package illustrated in FIG. 14 may be created from libraries consisting entirely of audio programming, or alternatively may be created from libraries that include a mixture of types of programming.

In FIG. 13, a consumer in step 240 requests programming, programming segments and secondary information relating to a hypothetical musician Z. The consumer can also further tailor the information provided in the content package by specifying further classifications and types of programming, as previously described.

The request is transmitted to a server 10 or 100. In step 242 the server searches the libraries 244, 246, 248, 250, 252, 254, 256 and 258 based on the consumer's specifications. Each of these libraries are stored in a database accessible by the server 10 or 100.

Once again, the programming libraries 244, 246 and 248 contain audio programming and possibly other forms of programming. The programming in these libraries, and any segmentation of the programming in these libraries, is preferably identified by topic through a database structure similar to the one described with respect to FIG. 8. Thus, the server 10 or 100 can identify programming and programming segments relevant to the topic and any other characteristics specified by the consumer.

Referring to FIG. 14, a content package showing programming, programming segments and secondary information relevant to the hypothetical musician Z is shown. Audio and audio/visual programming relating to the musician Z is illustrated on the left side of the content package. The secondary information relating to the hypothetical musician Z is illustrated on the right side of the content package.

As before, the secondary information is developed from non-programming libraries, such as libraries 250, 252, 254, 256 and 258. As before, these non-programming libraries are preferably created and cross-referenced to topics by the previously described database structure (see FIG. 8), as part of the service provided by the business implementing the server and the delivery of the programming.

While the present invention has been described with respect to the generation of content packages that contain television programming, quasi-reality programming and audio programming, it is to be appreciated that any of the types of programming described in this application or known to those skilled in the art can be utilized in the manner described herein. Thus, content packages can be generated from a wide range of types of programming and/or programming segments, in accordance with the present invention. Further, while the use of several topics have been illustrated, a wide variety of topics can be searched. By way of example only, movies, actors, bands, theater, genres in various field, sports, teams, history are but a few of the topics that can be explored in accordance with the principles of the present invention.

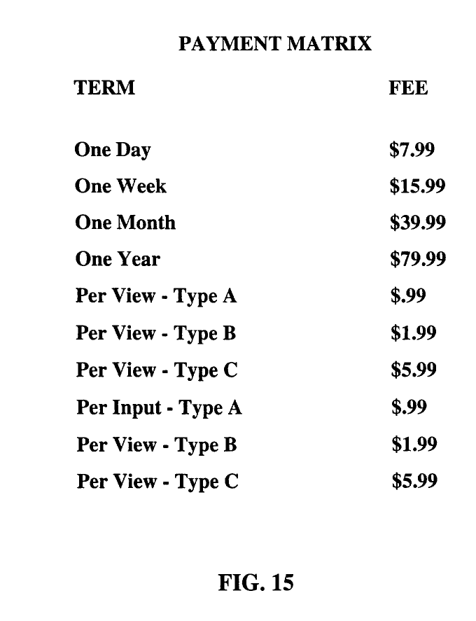

FIG. 15 illustrates a payment matrix that can be displayed to the consumer to indicate the pricing for viewing the programming. This method and system for charging and collecting fees for presenting programming in accordance with the present invention can be utilized as an alternative to the previously described method and system.

The Payment Matrix illustrated in FIG. 15 is preferably displayed as a popup window when a consumer desires to view the fee structure associated for paying for viewing programming in accordance with the present invention. In accordance with the Payment Matrix of FIG. 15, the consumer can select a fixed fee for unlimited viewing for a term. Thus, the fee for one day of unlimited viewing is $7.95. The fee for one week of unlimited viewing is $11.95. The fee for one month of unlimited viewing is $22.95. The fee for one year of unlimited viewing is $79.95. The consumer can select any of these unlimited viewing fee structures and the server 10 or 100 stores this information via conventional and well—known methods, thereby providing viewing of programming to paying consumers in accordance with the present invention.

The consumer can also choose to pay-per-view or per input. As illustrated in the Payment Matrix of FIG. 15, it is preferred to charge a fee in accordance with the type of programming being presented. Thus, Type A programming is programming which has lower value, Type B programming is programming having somewhat more value, and Type C programming is programming having the most value. Accordingly, greater fees are charged for Type C programming than are charged for Type A programming on a per view basis.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for presenting programming, the programming being related to one or more topics, comprising:
a plurality of database servers, each of the database servers being able to access a database that stores programming;
a client terminal capable of specifying a topic and sending a request for programming related to the topic; and
a main server connected to the plurality of database servers and to the client terminal, the main server being capable of receiving the request from the client terminal, querying the plurality of database servers to create a content package that includes programming related to the topic and sending the content package to the client terminal.

2. The system as claimed in claim 1, wherein the client terminal is capable of displaying the content package.

3. The system as claimed in claim 2, wherein the client terminal identifies selected programming from a displayed content package, the main server requests and receives the selected programming from the appropriate database server, and the main server transmits the selected programming to the client terminal.

4. The system as claimed in claim 3, wherein the selected programming is displayed on the client terminal.

5. The system as claimed in claim 4, wherein a fee for the display of the selected programming is charged.

6. The system as claimed in claim 3, wherein a fee for transmitting the selected programming from the database server is charged.

7. The system as claimed in claim 3, wherein a fee is stored in one of the databases in association with the selected programming.

8. The system as claimed in claim 1, wherein the programming is segmented and the segments are classified by topic, and the main server is capable of querying the database servers to identify programming segments related to the topic and then sending a list of the identified programming segments to the client terminal.

9. The system as claimed in claim 8, wherein the client terminal is capable of displaying the list of the identified programming and the list of the identified programming segments in a hierarchical fashion.

10. The system as claimed in claim 8, where the client terminal is capable of specifying whether the main server should send a list of programming or a list of programming segments.

11. The system as claimed in claim 8, further comprising the main server having a local database containing additional information relevant to the topic, wherein the main server is capable of querying the local database to identify the additional information relevant to the topic and including the additional information in the content package.

12. A method of presenting programming on a client terminal from a main server having access to a plurality of databases, each of the plurality of databases being maintained by a different business entity and containing a plurality of programming owned by the respective business entity, the programming being related to one or more topics, comprising the steps of:
specifying a topic at the client terminal;
sending a request to the main server from the client terminal for programming related to the topic;
at the main server, searching the plurality of databases for programming that is related to the topic;
at the main server, creating a content package that includes programming that is related to the topic; and
displaying a the content package at the client terminal.

13. The method as claimed in claim 11, further comprising the steps of:
on the client terminal, selecting programming from the content package; and
displaying the selected programming on the client terminal.

14. The method as claimed in claim 13, further comprising the step of:
charging a fee for displaying the programming.

15. A method for presenting programming, the programming being segmented into a plurality of segments, each of the segments being related to one or more topics, comprising the steps of:
selecting a topic;
creating a content package that includes a plurality of segments that relate to the topic;
displaying the content package;
selecting one of the plurality of segments from the content package; and
displaying the selected one of the plurality of segments.

16. The method as claimed in claim 15, wherein the content package further includes additional information related to the topic, the additional information being selected from one or more of the following categories: a quiz related to the topic; an e-book presentation relating to the topic; a recommended reading list having a plurality of references relating to the topic; a summary of the topic; a top ten list related to the topic; and internet links to additional sources related to the topic.

17. The method as claimed in claim 15, wherein the programming is fictional programming.

18. The method as claimed in claim 15, wherein the programming is non-fictional programming.

19. The method as claimed in claim 15, wherein the programming is quasi-reality based programming.

20. A system for presenting programming relating to a topic, the programming being segmented into a plurality of segments, comprising:
means for selecting the topic;
means for generating a content package that includes a plurality of segments that relates to the topic;
means for displaying the content package;
means for selecting one of the plurality of segments from the content package; and
means for displaying the selected one of the plurality of segments.

21. The system as claimed in claim 20, wherein the content package further includes additional information related to the topic, the additional information being selected from one or more of the following categories: a quiz related to the topic; an e-book presentation relating to the topic; a recommended reading list having a plurality of references relating to the topic; a summary of the topic; a top ten list related to the topic; and internet links to additional sources related to the topic.

22. The system as claimed in claim 21, wherein the programming is fictional programming.

23. The system as claimed in claim 21, wherein the programming is non-fictional programming.

24. The system as claimed in claim 21, wherein the programming is quasi-reality based programming.

25. A method for presenting television programming, the television programming being segmented into a plurality of segments, each of the plurality of segments being related to one or more topics, comprising the steps of:
selecting a topic;
creating a content package that includes a plurality of segments of television programming that relate to the topic; and
displaying the content package.

26. The method as claimed in claim 25, further comprising the steps of:
selecting one of the plurality of segments of television programming from the content package; and
displaying the selected one of the plurality of segments of television programming.

27. The method as claimed in claim 25, wherein the content package further includes additional information related to the topic, the additional information being selected from one or more of the following categories:
a quiz related to the topic; an e-book presentation relating to the topic; a recommended reading list having a plurality of references relating to the topic; a summary of the topic; a top ten list related to the topic; and internet links to additional sources related to the topic.

28. A system for presenting television programming, the television programming being segmented into a plurality of segments, each of the plurality of segments being related to one or more topics, comprising:
means for selecting a topic;
means for creating a content package that includes a plurality of segments of television programming that relate to the topic; and
means for displaying the content package.

29. The system as claimed in claim 28, further comprising:
means for selecting one of the plurality of segments of television programming from the content package; and
means for displaying the selected one of the plurality of segments of television programming.

30. The system as claimed in claim 28, wherein the content package further includes additional information related to the topic, the additional information being selected from one or more of the following categories: a quiz related to the topic; an e-book presentation relating to the topic; a recommended reading list having a plurality of references relating to the topic; a summary of the topic; a top ten list related to the topic; and internet links to additional sources related to the topic.

31. A method for presenting quasi-reality programming, the quasi-reality programming being segmented into a plurality of segments, the plurality of segments being related to one or more topics, comprising the steps of:
selecting a topic;
creating a content package that includes a plurality of segments of quasi-reality programming that relates to the topic; and
displaying the content package.

32. The method as claimed in claim 21, further comprising the steps of:
selecting one of the plurality of segments of quasi-reality programming from the content package; and
displaying the selected one of the plurality of segments of quasi reality programming.

33. The method as claimed in claim 32, wherein the segments are less than five minutes in length.

34. The method as claimed in claim 31, wherein the content package further includes additional information related to the topic, the additional information being selected from one or more of the following categories: a quiz related to the topic; an e-book presentation relating to the topic; a recommended reading list having a plurality of references relating to the topic; a summary of the topic; a top ten list related to the topic; and internet links to additional sources related to the topic.

35. The method as claimed in claim 31, wherein the quasi-reality program includes:
one or more presentations relating to the topic that present a conservative perspective of the topic;
one or more presentations relating to the topic that present a moderate perspective of the topic; and
one or more presentations relating to the topic that present a liberal perspective of the topic.

36. A system for presenting quasi-reality programming, the quasi-reality programming being segmented into a plurality of segments, the plurality of segments being related to one or more topics, comprising:
means for selecting a topic;
means for creating a content package that includes a plurality of segments of quasi-reality programming that relates to the topic; and
means for displaying the content package.

37. The system as claimed in claim 36, further comprising:
means for selecting one of the plurality of segments of quasi-reality programming from the content package; and
means for displaying the selected one of the plurality of segments of quasi-reality programming.

38. The system as claimed in claim 37, wherein the segments are less than five minutes in length.

39. The system as claimed in claim 36, wherein the content package further includes additional information related to the topic, the additional information being selected from on or more of the following categories: a quiz related to the topic; an e-book presentation relating to the topic; a recommended reading list having a plurality of references relating to the topic; a summary of the topic; a top ten list related to the topic; and internet links to additional sources related to the topic.

40. The system as claimed in claim 36, wherein the quasi-reality program includes:
one or more presentations relating to the topic that present a conservative perspective of the topic;
one or more presentations relating to the topic that present a moderate perspective of the topic; and
one or more presentations relating to the topic that present a liberal perspective of the topic.

41. A method of presenting information from a server to a client terminal, comprising the steps of:
specifying a topic at the client terminal;
sending the topic from the client terminal to the server;
at the server, searching a plurality of databases for programming and additional information that is related to the topic, the additional information including at least one of the following: a quiz related to the topic; a summary of the topic; a top ten list related to the topic; a game related to the topic, an e-book presentation relating to the topic, a recommended reading list relating to the topic, and internet links to websites related to the topic; and
creating and displaying a content package that includes a list of the programming and additional information in the database that is related to the topic.

42. The method as claimed in claim 41, wherein at least some of the programming is segmented.

43. A system for presenting information from a server to a client terminal, comprising:
means for specifying a topic at the client terminal;
means for sending the topic from the client terminal to the server;
at the server, means for searching a plurality of databases for programming and additional information that is related to the topic, the additional information including at least one of the following: a quiz related to the topic; a summary of the topic; a top ten list related to the topic; a game related to the topic, an e-book presentation relating to the topic, a recommended reading list relating to the topic, and internet links to websites related to the topic; and
means for creating and displaying a content package that includes a list of the programming and additional information in the database that is related to the topic.

44. The system as claimed in claim 43, wherein at least some of the programming is segmented.
